(19) United States
(12) Patent Application Publication
(10) Pub. No.: US 2017/0314305 A1
(43) Pub. Date: Nov. 2, 2017

(54) DOOR LOCK MECHANISM

(71) Applicants: Duane Beversdorf, Carson, CA (US); Angel Lopez, Carson, CA (US); Gabriela Aguilar, Carson, CA (US)

(72) Inventors: Duane Beversdorf, Carson, CA (US); Angel Lopez, Carson, CA (US); Gabriela Aguilar, Carson, CA (US)

(21) Appl. No.: 15/498,988

(22) Filed: Apr. 27, 2017

Related U.S. Application Data
(60) Provisional application No. 62/328,605, filed on Apr. 27, 2016.

(51) Int. Cl. E05C 9/04; E05C 1/06; E05C 9/10; E06B 9/00; E05B 65/00; E05C 1/00

(52) U.S. Cl. CPC E05C 9/04; E05C 1/06; E05C 9/10; E05B 65/00; E05C 1/00; E06B 9/00

(57) ABSTRACT

An improved door lock mechanism is a door locking device having heavy plates that sandwich the door frame above or below the door knob of a door with bolts passing through the plates to secure it to the door frame, and a barrel lock accessible through the outside plate with a barrel key. The locking mechanism is attached to a locking bar on the inside that is attached to a lock shaft rotatable on the door frame side which rotates downward into a slot formed in a plate that is attached to the inside of the door adjacent the frame plates. Together the frame plates, the door plate, and the rotating bar function as a door bar.

### CROSS-REFERENCE TO RELATED APPLICATION

The present application is related to and claims priority from prior provisional application Ser. No. 62/328,605, filed Apr. 27, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of door locks and more specifically relates to an improved door lock mechanism.

### 2. Description of the Related Art

There may have been times in the history of some societies that allowed the residents of homes to leave for periods of time and to leave the doors unlocked in case a traveler or a friend needed something, but those times are gone. Today, door locks are a necessary part of society because the days of a traveler using only what is needed are no longer. In today's world, thieves will take everything that will bring a buck to amass wealth for themselves at someone else's expense, and they will probably damage everything left behind for no reason at all. People are able to own more today than they can take when vacationing, which leaves a vacationing homeowner at risk. Door locks tend to prevent much of the intrusions but a thief having any interest will still get in because door locks can be picked by anyone who takes the time to watch free online videos on how to do it, or that can look up instructions on the internet. If nothing else, a good kick will destroy the wood of the door around the lock and it will open.

The available door locks on the market mount into the door but the thickness of the door wood is only about an inch and a half in width and since the bolt is mounted into the interior between the inner and outer surfaces, the strength is really about half that of the thickness. It can still be destroyed with a good kick or it can be picked quickly with lock tools that can be purchased in yard sales, swap meets, or bought online. The linear tumblers in conventional locks do not provide much security and the use of higher security locks tend to detract from the appearance of the home and have very expensive locking mechanisms so they are not used much for that reason. A solution is needed that does not weaken the integrity of the door and that has a locking system that is very difficult to pick while reinforcing, not dividing, the strength of the door.

Various attempts have been made to solve the above-mentioned problems such as those found in U.S. Pat. No. 7,958,647 to Nathan Gerner; U.S. Pat. No. 4,845,471 to Kans C. Chu; and U.S. Pat. No. 3,704,460 to Frank Stanley William. This art is representative of door locks. None of the above inventions and patents, taken either singly or in combination, is seen to describe the invention as claimed.

Ideally, a door lock should provide increased difficulty in lock picking while reinforcing the door, and yet, would operate reliably and be manufactured at a modest expense. Thus, a need exists for a reliable an improved door lock mechanism to avoid the above-mentioned problems.

### BRIEF SUMMARY OF THE INVENTION

In view of the foregoing disadvantages inherent in the known door lock art, the present invention provides a novel improved door lock mechanism. The general purpose of the present invention, which will be described subsequently in greater detail, is to provide increased difficulty in lock picking while reinforcing the door.

The improved door lock mechanism preferably comprises two plate members adapted to be located on opposite sides of a door frame and securely bolted together through the door frame, at least two bolt members adapted to pass through the door frame and securely connect the two plate members together from opposite sides of the door frame, a door plate member adapted to be securely attached to the surface of the door member at a position in proximity to one of the two plate members and adapted to releasably and securely receive a latch member.

The latch member movably attaches to the two plate members and is adapted to removably engage with the door plate member such that the improved door lock mechanism is adapted to securely and releasably lock a door member in a closed position with respect to a door frame that the door member is mounted upon. A lock member is located on one of the two plate members that is opposite from the plate member and in proximity to the door plate member. The lock member is mechanically connected to the latch member and a key member is adapted to move the lock member and thereby the latch member into and out of engagement with the door plate member.

The key member is formed as a barrel key adapted to rotate the lock member and thereby move the latch member into and out of engagement with the door plate member. The key member may be formed as a digital keypad in some embodiments and adapted to move the lock member and thereby the latch member into and out of engagement with the door plate member.

The door plate member is formed having a main plate portion adapted to be securely attached to the door member, and a latch plate portion extending from the main plate portion and formed having an L-shape such that the main plate portion and the latch plate portion form a slot adapted to releasably engage the latch member. The latch member includes a handle portion adapted to allow a person to move the latch member into and out of engagement positions with the door plate member. An alarm member may be adapted to emit an audible signal upon the detection of a person trying to pick the lock or use a counterfeit key member. A viewing lens member extends between and through each of the two plate members and is adapted to allow a person on one side of the door member to view someone on the opposite side of the door member.

There may be four bolt members used to connect the two plate members and sandwich the inner and outer surfaces of the door frame, with the bolt members passing through holes in the door frame to secure the plate members into position. The two plate members, the bolt member(s), the door plate member, and the latch member are formed from a material chosen from a group of materials consisting of iron, steel, and ceramic.

The invention may comprise the combination of a door member, a door frame, and an improved door lock mechanism with the door member adapted to be pivotally connected to the door frame. The door frame includes two spaced vertical door frame members and a horizontal door frame member connected between upper end portions of the two spaced vertical door frame members, and with the door member pivotally connected to the door frame. The improved door lock mechanism preferably comprises two plate members adapted to be located and secured upon opposite sides of one of the two spaced vertical door frame members of the door frame and securely bolted together through and to the door frame. At least two bolt members are adapted to pass through one of the two spaced vertical door frame members and securely connect the two plate members together upon one of the two spaced vertical door frame members. A door plate member is adapted to be securely attached to the surface of the door member at a position in proximity to one of the two plate members and adapted to releasably and securely receive the latch member. The latch member is movably attached to the two plate members and is adapted to removably engage with the door plate member.

When in use, the improved door lock mechanism is adapted to securely and releasably lock the door member in a closed position with respect to the door frame. A lock member is located on one of the two plate members that is opposite from the plate member in proximity to the door plate member and is connected to the latch member. A key member is adapted to move the lock member and thereby the latch member into and out of engagement with the door plate member. The key member is formed as a barrel key adapted to rotate the lock member and thereby move the latch member into and out of engagement with the door plate member. The key member, in some embodiments, may be formed as a digital keypad adapted to move the lock member and thereby the latch member into and out of engagement with the door plate member.

The door plate member is formed having a main plate portion adapted to be securely attached to the door member, and a latch plate portion extending from the main plate portion and formed having an L-shape, such that the main plate portion and the latch plate portion form a slot adapted to releasably engage the latch member. The latch member includes a handle portion adapted to allow a person to move the latch member into and out of engagement positions with the door plate member manually. An alarm member is adapted to emit an audible signal when there is a detection of a person trying to pick the lock or use a counterfeit key member. A viewing lens member extends between and through each of the two plate members and is adapted to pass through the door frame to allow a person on one side of the door member to view someone on the opposite side of the door member. There may be four bolt members used to connect the two plate members and sandwich the inner and outer surfaces of the door frame, with the bolt members passing through holes in the door frame to secure the plate members into position. The two plate members, the bolt members, the door plate member, and the latch member are all formed from a material chosen from a group of materials consisting of iron, steel, and ceramic.

The present invention holds significant improvements and serves as an improved door lock mechanism. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved door lock mechanism, constructed and operative according to the teachings of the present invention.

FIG. 1 shows a perspective view illustrating an improved door lock mechanism according to an embodiment of the present invention.

FIG. 2 is a perspective view illustrating the inside portion of the improved door lock mechanism according to an embodiment of the present invention of FIG. 1.

FIG. 3A is a perspective view illustrating the outside portion of a keyed embodiment of the improved door lock mechanism according to an embodiment of the present invention of FIG. 1.

FIG. 3B is a perspective view illustrating the outside portion of a keypad embodiment of the improved door lock mechanism according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a door lock and more particularly to a an improved door lock mechanism as used to increase difficulty in lock picking while reinforcing the door.

Generally speaking, an improved door lock mechanism is a door locking device having heavy plates that sandwich the door frame above or below the door knob of a door with bolts passing through the plates to secure it to the door frame, and a barrel lock accessible through the outside plate with a barrel key. The locking mechanism is attached to a locking bar on the inside that is attached to a lock shaft rotatable on the door frame side which rotates downward into a slot formed in a plate that is attached to the inside of the door adjacent the frame plates. Together the frame plates, the door plate, and the rotating bar function as a door bar.

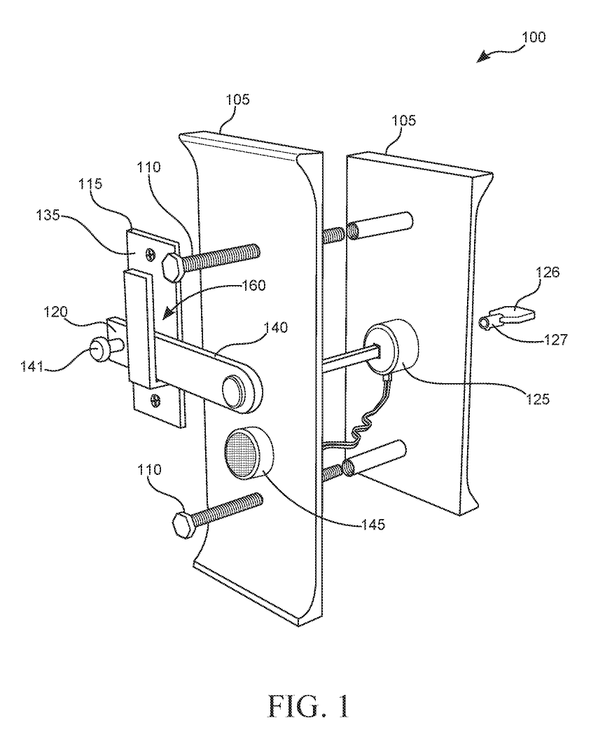

In greater detail now, referring to the drawings by numerals of reference there is shown in FIG. 1, a perspective view illustrating improved door lock mechanism 100 according to an embodiment of the present invention.

Improved door lock mechanism 100 preferably comprises two plate members 105 adapted to be located on opposite sides of door frame 106 and securely bolted together through door frame 106, at least two bolt members 110 adapted to pass through door frame 106 and securely connect the two plate members 105 together from opposite sides of door frame 106, door plate member 115 adapted to be securely attached to the surface of door member 155 at a position in proximity to one of the two plate members 105 and adapted to releasably and securely receive latch member 120.

Latch member 120 movably attaches to the two plate members 105 and is adapted to removably engage with door plate member 115 such that improved door lock mechanism 100 is adapted to securely and releasably lock door member 155 in a closed position with respect to door frame 106 that door member 155 is mounted upon. Lock member 125 is located on one of the two plate members 105 that is opposite from plate member 105 and in proximity to door plate member 115. Lock member 125 is mechanically connected to latch member 120 key member 126 is adapted to move lock member 125 and thereby latch member 120 into and out of engagement with door plate member 115.

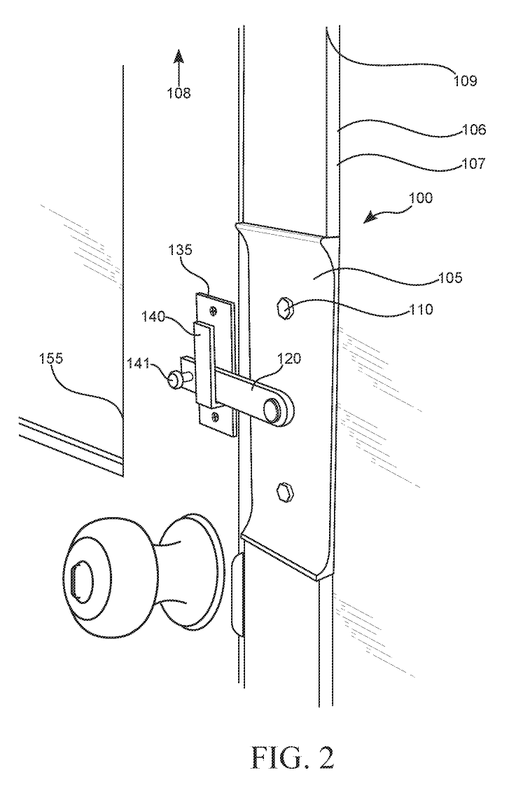

Referring now to FIG. 2, is a perspective view illustrating the inside portion of improved door lock mechanism 100 according to an embodiment of the present invention of FIG. 1.

Door plate member 115 is formed having main plate portion 135 adapted to be securely attached to door member 155, and latch plate portion 140 extending from main plate portion 135 and formed having an L-shape such that main plate portion 135 and latch plate portion 140 form a slot adapted to releasably engage latch member 120. Latch member 120 includes handle portion 141 adapted to allow a person to move latch member 120 into and out of engagement positions with door plate member 115. Alarm member 145 may be adapted to emit an audible signal upon the detection of a person trying to pick lock member 125 or use a counterfeit key member. Alarm member 145 is optional and improved door lock mechanism 100 may be manufactured without this option. Viewing lens member 150 extends between and through each of the two plate members 105 and is adapted to allow a person on one side of door member 155 to view someone on the opposite side of door member 155. Viewing lens member 150 is optional and improved door lock mechanism 100 may be manufactured without this option.

There may be four bolt members 110 used to connect the two plate members 105 and sandwich the inner and outer surfaces of door frame 106, with bolt members 110 passing through holes in door frame 106 to secure plate members 105 into position. The two plate members 105, bolt members 110, door plate member 115, and latch member 120 are formed from a material chosen from a group of materials consisting of iron, steel, and ceramic.

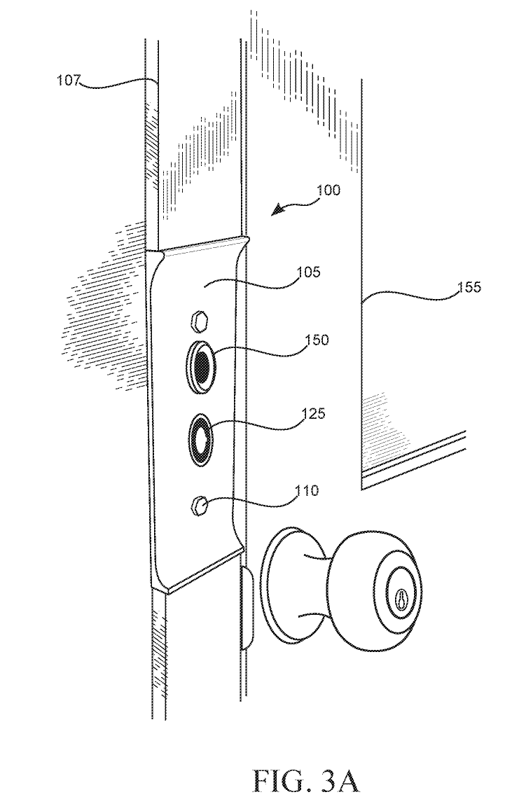

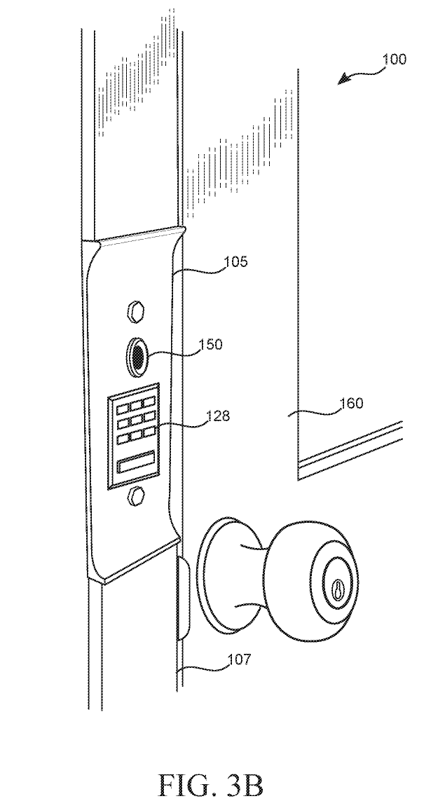

Referring now to FIG. 3A, is a perspective view illustrating the outside portion of a keyed embodiment of improved door lock mechanism 100 according to an embodiment of the present invention of FIG. 1.

Key member 126 is formed as barrel key 127 adapted to rotate lock member 125 and thereby move latch member 120 into and out of engagement with door plate member 115. Key member 126 is formed as barrel key 127 adapted to rotate lock member 125 and thereby move latch member 120 into and out of engagement with door plate member 115. Key member 126, in some embodiments, may be formed as digital keypad 128 adapted to move lock member 125 and thereby latch member 120 into and out of engagement with door plate member 115.

The invention may comprise the combination of door member 155, door frame 106, and improved door lock mechanism 100 with door member 155 adapted to be pivotally connected to door frame 106. Door frame 106 includes two spaced vertical door frame member107 and horizontal door frame member 108 connected between upper end portions 109 of the two spaced vertical door frame member107, and with door member 155 pivotally connected to door frame 106. Improved door lock mechanism 100 preferably comprises two plate members 105 adapted to be located and secured upon opposite sides of one of the two spaced vertical door frame members 107 of door frame 106 and securely bolted together through and to door frame 106. At least two bolt members 110 are adapted to pass through one of the two spaced vertical door frame member107 and securely connect the two plate members 105 together upon one of the two spaced vertical door frame member107. Door plate member 115 is adapted to be securely attached to the surface of door member 155 at a position in proximity to one of the two plate members 105 and adapted to releasably and securely receive latch member 120. Latch member 120 is movably attached to the two plate members 105 and is adapted to removably engage with door plate member 115.

Door plate member 115 is formed having main plate portion 135 adapted to be securely attached to door member 155, and latch plate portion 140 extending from main plate portion 135 and formed having an L-shape, such that main plate portion 135 and latch plate portion 140 form slot 160 adapted to releasably engage latch member 120. Latch member 120 includes handle portion 141 adapted to allow a person to move latch member 120 into and out of engagement positions with door plate member 115 manually. Alarm member 145 is adapted to emit an audible signal when there is a detection of a person trying to pick lock member 125 or use a counterfeit key member 126. Viewing lens member 150 extends between and through each of the two plate members 105 and is adapted to pass through door frame 106 to allow a person on one side of door member 155 to view someone on the opposite side of door member 155.

Referring now to FIG. 3B, showing a perspective view illustrating the outside portion of a keypad embodiment of improved door lock mechanism 100 according to an embodiment of the present invention of FIG. 1.

Key member 126 may be formed as digital keypad 128 in some embodiments and adapted to move lock member 125 and thereby latch member 120 into and out of engagement with door plate member 115. When in use, improved door lock mechanism 100 is adapted to securely and releasably lock door member 155 in a closed position with respect to door frame 106. Lock member 125 is located on one of the two plate members 105 that is opposite from plate member 105 in proximity to door plate member 115 and is connected to latch member 120. Key member 126 is adapted to move lock member 125 and thereby latch member 120 into and out of engagement with door plate member 115.

There may be four bolt members 110 used to connect the two plate members 105 and sandwich the inner and outer surfaces of door frame 106, with bolt members 110 passing through holes in door frame 106 to secure plate members 105 into position. The two plate members 105, bolt members 110, door plate member 115, and latch member 120 are all formed from a material chosen from a group of materials consisting of iron, steel, and ceramic.

The improved door lock mechanism 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., specific assembly contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An improved door lock mechanism comprising:
two plate members;
wherein said two plate members are adapted to be located on opposite sides of a door frame and securely bolted together through and to said door frame;
at least two bolt members;
wherein said at least two bolt members are adapted to pass through said door frame and securely connect said two plate members together and on to said opposite sides of said door frame;
a door plate member;
wherein said door plate member is adapted to be securely attached to a surface of a door member at a position in proximity to one of said two plate members and adapted to releasably and securely receive a latch member; and
a latch member;
wherein said latch member is movably attached to said two plate members and is adapted to removably engage with said door plate member;
wherein when in use said improved door lock mechanism is adapted to securely and releasably lock a door member in a closed position with respect to a door frame said door member is mounted thereon.

2. The improved door lock mechanism of claim 1, further comprising a lock member located on one of said two plate members that is opposite from said plate member in proximity to said door plate member; wherein said lock member is in mechanically connected to said latch member; and a key member adapted to move said lock member and thereby said latch member into and out of engagement with said door plate member.

3. The improved door lock mechanism of claim 2, wherein said key member is formed as a barrel key adapted to rotate said lock member and thereby move said latch member into and out of engagement with said door plate member.

4. The improved door lock mechanism of claim 2, wherein said key member is formed as a digital keypad adapted to move said lock member and thereby said latch member into and out of engagement with said door plate member.

5. The improved door lock mechanism of claim 1, wherein said door plate member is formed having a main plate portion adapted to be securely attached to a door member, and a latch plate portion extending from said main plate portion and formed having an L-shape, such that said main plate portion and said latch plate portion from a slot adapted to releasably engage said latch member.

6. The improved door lock mechanism of claim 1, wherein said latch member includes a handle portion adapted to allow a person to move said latch member into and out of engagement positions with said door plate member.

7. The improved door lock mechanism of claim 1, further comprising an alarm member adapted to emit an audible signal upon the detection of a person trying to pick said lock or use a counterfeit key member.

8. The improved door lock mechanism of claim 1, further comprising a viewing lens member extending between and through each of said two plate members and is adapted to allow a person on one side of said door member to view someone on the opposite side of said door member.

9. The improved door lock mechanism of claim 1, wherein there are four bolt members.

10. The improved door lock mechanism of claim 1, wherein said two plate members, said at least two bolt members, said door plate member, and said latch member are formed from a material chosen from a group of materials consisting of iron, steel, and ceramic.

11. A combination of a door member, a door frame, and an improved door lock mechanism, said combination comprising:
a door member;
wherein said a door member is adapted to be pivotally connected to a door frame;
a door frame including:
two spaced vertical door frame members; and
a horizontal door frame member connected between upper end portions of said two spaced vertical door frame members;
wherein said door member is pivotally connected to said door frame; and
an improved door lock mechanism comprising:
two plate members;
wherein said two plate members are adapted to be located and secured upon opposite sides of one of said two spaced vertical door frame members of said door frame and securely bolted together through and to said door frame;
at least two bolt members;
wherein said at least two bolt members are adapted to pass through said one of said two spaced vertical door frame members and securely connect said two plate members together and upon said one of said two spaced vertical door frame members;
a door plate member;
wherein said door plate member is adapted to be securely attached to a surface of said door member at a position in proximity to one of said two plate members and adapted to releasably and securely receive a latch member; and
a latch member;
wherein said latch member is movably attached to said two plate members and is adapted to removably engage with said door plate member;
wherein when in use said improved door lock mechanism is adapted to securely and releasably lock said door member in a closed position with respect to said door frame.

12. The combination of claim 11, further comprising a lock member located on one of said two plate members that is opposite from said plate member in proximity to said door plate member; wherein said lock member is in mechanically connected to said latch member; and a key member adapted to move said lock member and thereby said latch member into and out of engagement with said door plate member.

13. The improved door lock mechanism of claim 12, wherein said key member is formed as a barrel key adapted to rotate said lock member and thereby move said latch member into and out of engagement with said door plate member.

14. The improved door lock mechanism of claim 12, wherein said key member is formed as a digital keypad adapted to move said lock member and thereby said latch member into and out of engagement with said door plate member.

15. The improved door lock mechanism of claim 11, wherein said door plate member is formed having a main plate portion adapted to be securely attached to said door member, and a latch plate portion extending from said main plate portion and formed having an L-shape, such that said main plate portion and said latch plate portion from a slot adapted to releasably engage said latch member.

16. The improved door lock mechanism of claim 11, wherein said latch member includes a handle portion adapted to allow a person to move said latch member into and out of engagement positions with said door plate member.

17. The improved door lock mechanism of claim 11, further comprising an alarm member adapted to emit an audible signal upon the detection of a person trying to pick said lock or use a counterfeit key member.

18. The improved door lock mechanism of claim 11, further comprising a viewing lens member extending between and through each of said two plate members, is adapted to pass through said door frame, and is adapted to allow a person on one side of said door member to view someone on the opposite side of said door member.

19. The improved door lock mechanism of claim 11, wherein there are four bolt members.

20. The improved door lock mechanism of claim 11, wherein said two plate members, said at least two bolt members, said door plate member, and said latch member are formed from a material chosen from a group of materials consisting of iron, steel, and ceramic.
